(19) United States
(12) Patent Application Publication
(10) Pub. No.: US 2002/0124703 A1
(43) Pub. Date: Sep. 12, 2002

(54) Automated in-line nested drop cut attachment apparatus

(76) Inventor: Kenneth A. Stevens, Batavia, IL (US)

Correspondence Address: Glenn W. Ohlson, Lee, Mann, Smith, McWilliams,, Sweeney & Ohlson, P.O. Box 2786, Chicago, IL, 60690-2786, US

(21) Appl. No.: 10/092,098

(22) Filed: Mar. 6, 2002

Related U.S. Application Data
(60) Provisional application No. 60/274,871, filed on Mar. 9, 2001.

(51) Int. Cl. B26D 5/20; B26D 7/02

(52) U.S. Cl. 83/282; 83/672; 83/934

(57) ABSTRACT

The present invention relates to an automated in-line drop cut apparatus comprising a drop cut unit and a pathway for receiving folded documents from an upstream feeder and transporting said documents to and from the drop cut unit. The drop cut unit includes at least one cutter for cutting the folded documents along a document folded edge parallel to the direction of document travel, said cutter being positioned adjacent said pathway. A method of producing nested drop cut documents in-line is also provided by this invention.

### RELATED APPLICATIONS

This application claims the benefit of U.S. Provisional Patent Application Serial No. 60/274,871 filed Mar. 9, 2001.

### BACKGROUND OF THE INVENTION

The present invention is directed to the “dropping” (separation) of a panel of the primary piece. The present invention provides an apparatus and method by which a one-piece single sheet of paper, typically 11″/to 17″ long, and originating from either a single cut sheet document or a continuous document form, is processed through a combination of folder and cutter assemblies resulting in a folded document with a loose detached sheet (“drop cut”) inside formed from the original one-piece sheet of paper. The term “drop” means separated from the folded piece.

The prior art method of providing the loose detached piece, or drop cut, is currently accomplished off-line wherein the document originates from a continuous form, is cut to size, and delivered to a folder. It can also originate from a cut sheet feeder. The sheet is usually folded 2-3 times through a first folding unit to form a folded form having a drop cut fold edge extending beyond the rest of the folded form. After folded, it is delivered in a landscape orientation (longest side first) and perpendicular to a right angle alignment table, which then transports the folded document—now in a portrait orientation (short side first)—to a second fold unit. The second fold unit is only used to change orientation and transport the document through a set of slitting wheels. These slitter wheels cut a ⅛″ strip (typically) from the drop cut fold edge of the document as it passes through the slitter wheels. After this is accomplished the document is delivered to a shingling conveyor. The document now has a “loose” or drop cut slip sheet inside. The documents are then gathered and hand delivered to an inserter machine for inserting them usually into envelopes for mailing to customers.

The foregoing prior art technique is inefficient. Separate folding equipment is needed that is usually run by a bindery equipment operator. Once the cut documents are on a conveyor they have to be manually handled, usually kept in order, stacked in a mail tray or boxing, and delivered to the inserting operation. Chances to breach the integrity of the operation are numerous, as would be understood by those skilled in the art.

The throughput in the off-line folding and slitting process can be up to 6500 finished documents per hour. Once these documents are brought to the inserter processing, speeds are approximately 2500 finished envelopes per hour. With the applicant's inserter machine there is no need to buy additional folding equipment or require extra manpower.

### SUMMARY OF THE INVENTION

The present invention is a method and an apparatus to automate what is known as drop cutting by combining the inserting and nested drop cut processes in one operation. This can increase production as much as 50% compared to prior art off-line procedures. It also guarantees a greater degree of quality and integrity.

Forms may be processed through a variety of document processor technologies, including continuous, friction feeders (i.e., booklets) and cut sheet. The documents are folded to produce a form having a drop cut fold edge in an upstream paper processing assembly and do not require a right angle attachment. The folded documents are transported directly to the inserter, i.e., such as those made by EMC Document Systems, Inc., Bell & Howell, Pitney Bowes, Mailcrafters, Juki, or H. M. Surchin, via an insert raceway track pathway. Once in the insert raceway track and prior to the inserter, the folded document travels downstream to an automated nested drop cut unit. The automated nested drop cut unit includes at least one cutting assembly operable to sever the drop cut piece from the document. The cutting assembly comprises a rotary blade and complementary anvil blade operable to be selectively positioned adjacent the insert raceway track with the rotary blades rotational axis parallel to the drop cut fold edge. The rotary blade comprises a rotatable tube or drum and a diagonally spaced blade that runs the length thereof. Preferably, the automated nested drop cut unit includes two cutting assemblies positioned on either side of the insert raceway track such that either or both document edges may contain a drop cut fold edge and may both be cut. The cutting assemblies are preferably independently and adjustably mounted operable to be positioned by lead screws linked to hand wheels placed at the front of the machine. Thus, since the unit can cut either or both sides of the document, orientation of the document is flexible, which is important to the operator, i.e., for address location and orientation.

The folded document is guided to the automated nested drop cut unit via pusher pins that are preferably belt or chain driven. For proper alignment with respect to the cutting assembly and to assure an accurate cut, a hold down apparatus and side rails are provided to secure the document with a drop cut edge side toward one of the two rotary cutting blades. Once the downstream inserter or other mechanism cycles to a stopped position, the rotary blade rotates 360° slicing the drop cut fold edge of the document off, removing the drop cut fold, or chip, and disposing it into a trash container below. Upon the next machine cycle, the separated document, now with a nested drop cut piece, advances and the next document is introduced to the rotary cutting blade.

A direct drive method is preferably used to simplify operation, set-up, and maintenance. For gripper arm machines, such as those made by EMC Document Systems, Inc., Bell & Howell, Pitney Bowes, Mailcrafters, Juki, or H. M. Surchin, an extended drive shaft is supplied to connect the cutting assembly directly to the existing inserter's main drive shaft. Alternatively for other types of inserters, a drive motor and encoder would be provided to time the cut cycle. An electronically controlled system is preferably provided for monitoring trim disposal, blade position (in relation to inserter position), blade cycles, jam identification and safety to interlock status.

### BRIEF DESCRIPTION OF THE DRAWINGS

FIG. 1 A is an expanded view showing the folding and cutting of a single sheet to provide a nested drop cut inner single loose sheet, which is created by cutting along the dashed cut line;

FIG. 1B is a perspective view showing a folded document having an extended drop cut fold edge;

FIG. 1C is an expanded view of a folded document showing a nested drop cut inner single loose sheet separated, i.e. “dropped”, from the document;

FIG. 1 D is a perspective of a folded document containing the nested inner single loose sheet of FIG. 1C separated from the document;

FIG. 2 is a schematic plan view of a feeder in combination with the automated nested drop cut unit having cutters at both sides of the insert track;

FIG. 3 is an elevational view of the rotary cutter of the the automated nested drop cut unit;

FIG. 4 is a schematic cross-sectional view showing the rotary cutter adjacent the insert track and the relationship of the pusher pins for moving the document to the cutter having the document edge atop an anvil blade; and

FIG. 5 is a plan view of the nested drop cut unit cutters in relation to either side of the insert track; and

FIG. 6 is a perspective view looking downstream and downward on the insert track as in FIG. 5 and showing documents being moved by pusher pins and clamped in the track adjacent one rotary cutter while urged atop the anvil blade.

### DETAILED DESCRIPTION OF THE INVENTION

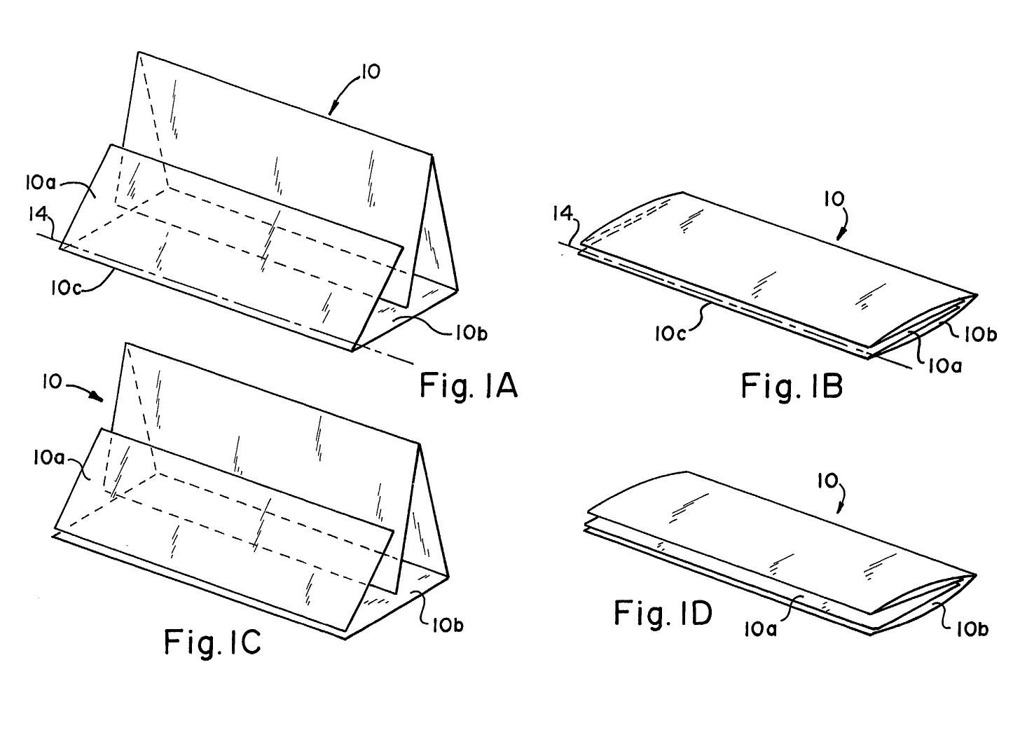

The present invention is an apparatus and method to automate nested drop cut attachment applications by processing the inserting and nested drop cut process (FIGS. 1A-1D) in one operation, or “in-line.” This can increase production as much as 50% or more as compared to prior art off-line techniques. It also affords a greater degree of quality and integrity to the processing operation and a decrease in personnel and equipment costs.

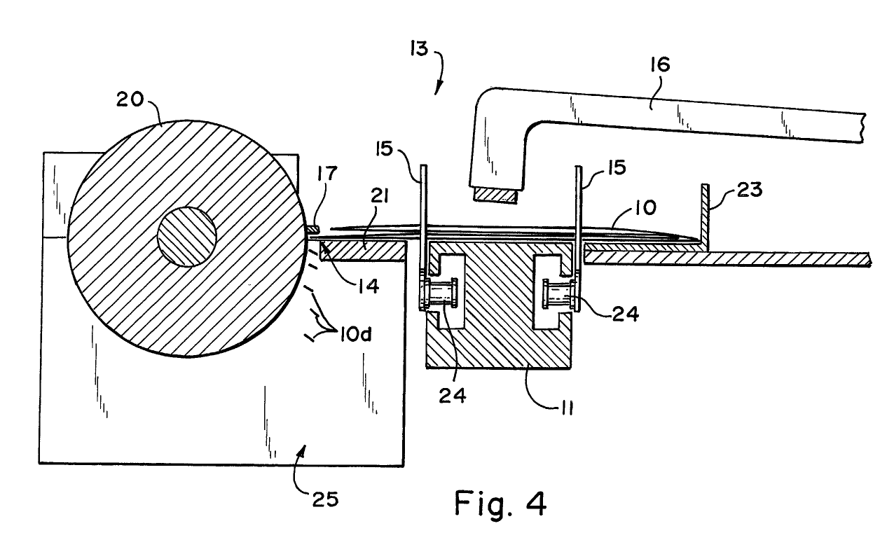

FIGS. 1A through 1D show four views of the folding and site of cutting of a single sheet of material to provide a nested drop cut inner single loose sheet, which is created by cutting along the superimposed dashed cut line (14). FIG. 1A shows a document (10) having an inner drop cut panel or page (10a), a drop cut fold edge (10c) and a lower document panel (10b). As illustrated in FIG. 1B, the drop cut fold edge (10c) extends beyond the rest of the folded document (10) with the cut line (14) inward of the drop cut fold edge such that during the cutting process, both the drop cut panel (10a) and the lower document panel (10b) will be cut thereby separating the drop cut panel (10a) from the rest of the document (10) and nesting the drop cut panel (10a) therein. When nested, the drop cut panel (10a) (FIG. 1D) is loose. The cuts taken off, or chips (10d) (see FIG. 4), are typically about ⅛″. Thus, the folded non-cut panels of a document (10) are folded to be about ⅛″ less in width in order to be about the same width as the drop cut panel (10a) after cutting. The folded and uncut forms may be processed through a variety of document processor technologies, including continuous and cut sheet, or friction feeder (i.e., booklets).

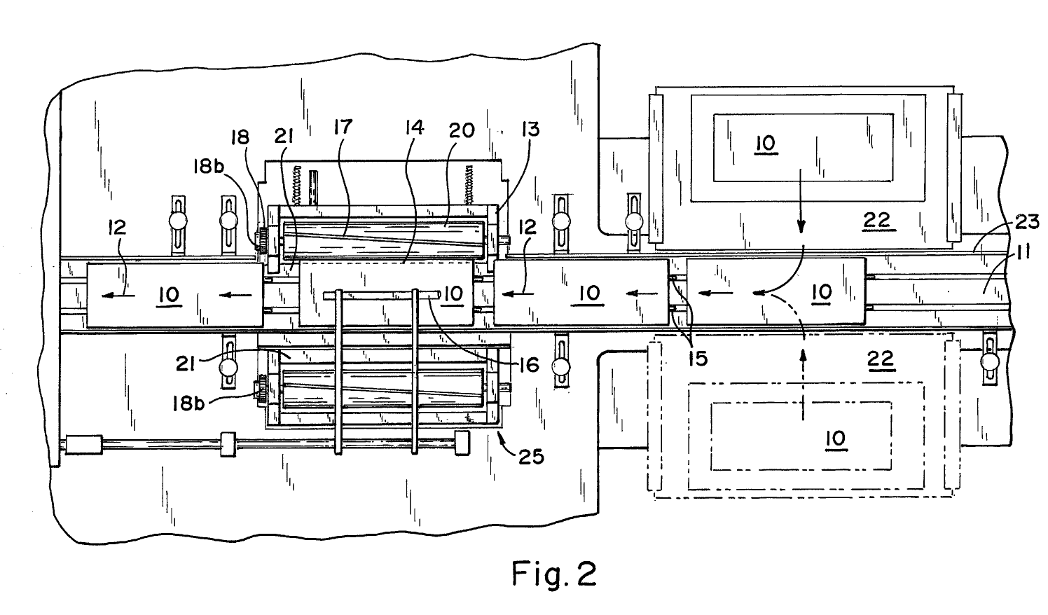

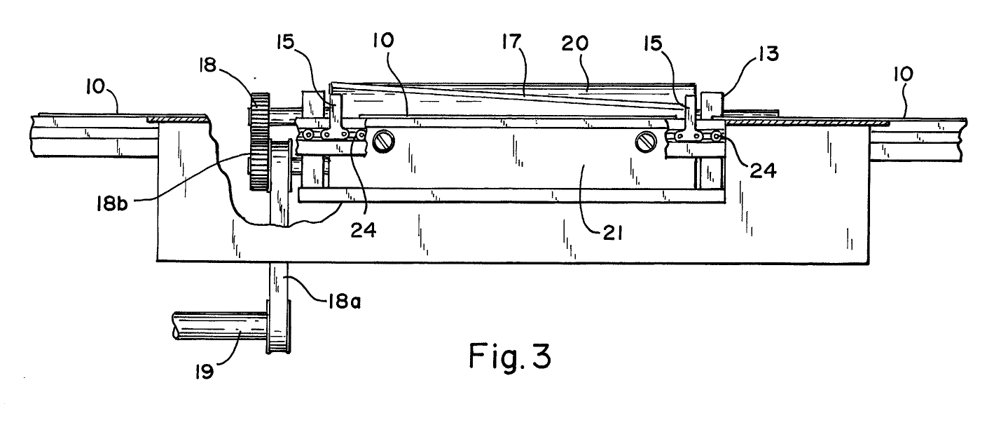

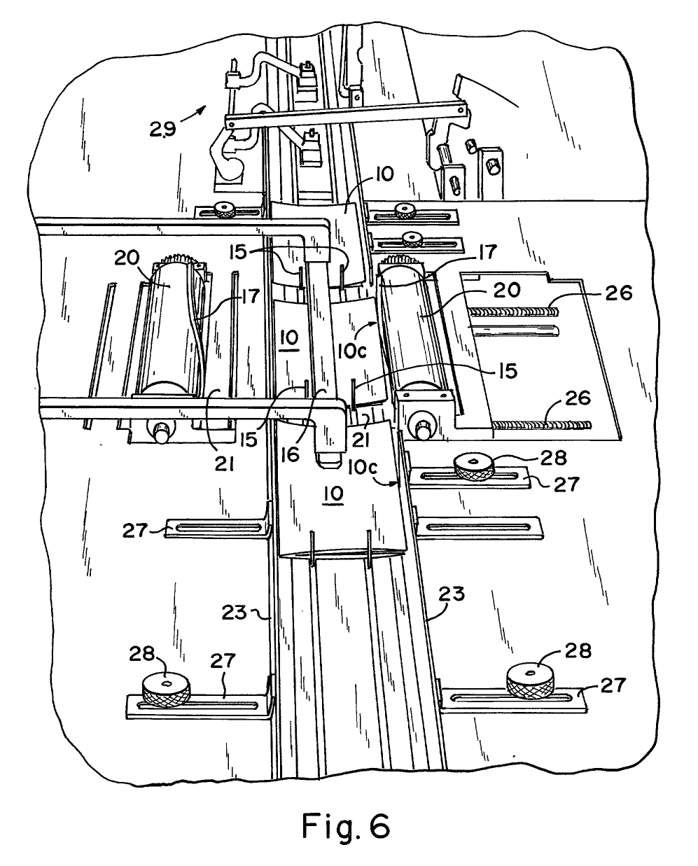

In the preferred embodiment, the documents (10) are folded by known upstream equipment (not shown in detail) and do not require a right angle attachment for orientation prior to cutting. The documents (10) are carried in the downstream direction (12), for example to an inserter (29) (see FIG. 6), such as those manufactured by EMC Document Systems, Inc., Bell & Howell, Pitney Bowes, Mailcrafters, Juki, or H. M. Surchin, by way of a pathway, such as shown at raceway insert track (11). Documents (10) are inserted or fed onto the raceway insert track (11) from the upstream equipment, such as a folder or friction feeder, by means of a feeder (22). The raceway insert track (11) includes a rail (23) for guiding the document (10) along its path of travel. Optionally, documents may be fed from each side of the raceway insert track (11) as shown in FIG. 2, i.e. alternating from one side to the other during the same run of documents or switching feed sides for different runs. Also, while FIG. 2 shows two feeders (22) for feeding documents (10) onto the raceway insert track (11), documents (10) may be fed from multiple different upstream folders or friction feeders positioned on either side of the raceway insert track (11). The arrows in FIG. 2 show the feeding path of transport along the pathway, or insert track (11).

Once in the raceway insert track (11), the document (10) travels downstream (12) to an automated nested drop cut unit (13). As best shown in FIG. 2, the automated nested drop cut unit (13) comprises at least one cutter, such as shown at cutting assembly (25). The cutting assembly (25) is adjustable by a set of lead screws (26) to be selectively positioned adjacent the raceway insert track (11) to account for different sized documents. A plurality of side rails (23) including adjustment arms (27) and thumbscrew adjustments (28) allow an operator to adjust the raceway insert track (11) width for different sized documents (10) for different processing applications.

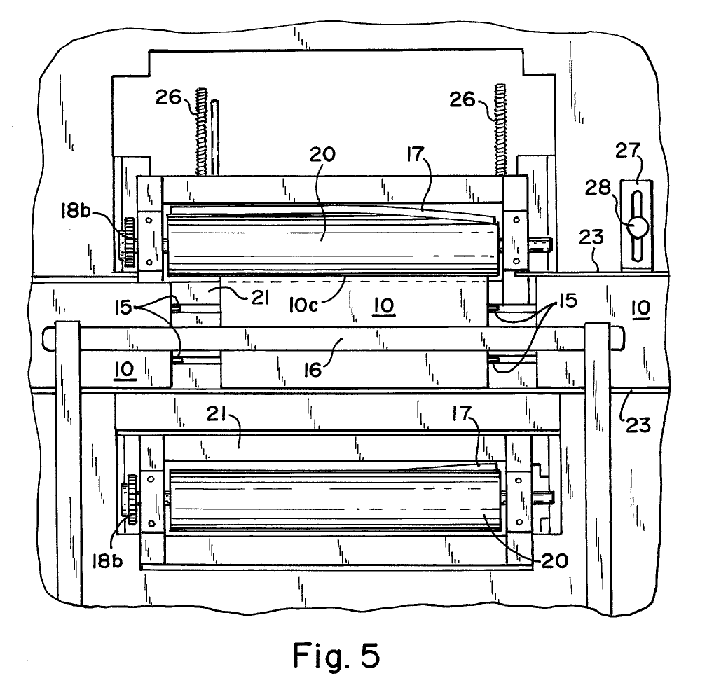

The cutting assembly (25) includes a rotary tube or drum (20) having a diagonal rotary cutting blade (17) operable with a complementary anvil blade (21) positioned adjacent to the blade (17) and adapted to support the document (10) during cutting. Preferably and as shown in FIG. 2, the automated nested drop cut unit (13) includes two cutting assemblies, with one cutting assembly (25) positioned on each side of the raceway insert track (11). As previously described, the cutting assemblies (25) are preferably operable to be selectively positioned with respect to the raceway insert track (11). For this purpose, the cutting assemblies are mounted with said lead screws (26) (shown in FIG. 5) linked to hand wheels (not shown) on the front of the apparatus. Since the automated nested drop cut unit (13) can cut either or both sides of the document (10), the orientation of the document (10) entering the raceway insert track (11) is flexible, which is important, for example: address location and orientation.

The document (10) is guided into the automated nested drop cut unit apparatus (13) via pusher pins (15) riding on chain drive (24) carried by insert track (11). For proper alignment and to assure an accurate cut line (14), a hold down apparatus (16) and rail (23) (shown in FIG. 4) are provided to secure and position the document (10) against the drum (20) of one of two cutting assemblies (25) and the associated anvil blade (21). The invention utilizes the tube or drum (20) as a guide for the edge of the document (10) that is to be cut. Once the downstream inserter (29) cycles to a stopped position, the rotary drum (20) with blade (17) rotates 360° slicing the edge at cut line (14) of the document (10) off (shown in FIG. 1 and FIG. 4), thereby removing the chip, or cut-away scrap, and disposing it into a trash container below. The blade (17) cuts in a spiral sweeping motion due to the diagonal arrangement along the rotary drum (20). The blade (17) is sequenced at one rotation per piece. At the next machine cycle, the cut document (10) with nested drop cut advances downstream and the following uncut document (10) is introduced to the cutting assembly (25).

The automated drop cut unit apparatus (13) is preferably driven as part of the downstream inserter (29), which gives the timing sequence effect but could be operated by separate motive force guided by separate electronics. Other secondary or tertiary inserts for a mailing piece may be placed on top later. A direct drive (18) means of operation is preferably used to simplify operation, set-up and maintenance. For operation with well known downstream gripper arm machines for picking and inserting documents into envelopes, such as made by EMC, Bell & Howell, Pitney Bowes, Mailcrafters, Juki, or H. M. Surchin, an extended drive shaft (19) is supplied to connect directly to the downstream inserter's (29) main drive shaft (not shown). The direct drive includes a drive belt (18a), or other suitable connection, engaged by the extended drive shaft (19). The drive belt (18a) in turn engages drive gear assembly (18b) linked to the rotary drum (20) of the cutting assembly (25), thereby transferring motive force from the inserter's (29) main drive shaft to the rotary drum 20). A clutch (not shown) is directly connected to the cutters to protect the cutting assemblies (25). For use with other types of inserters, a drive motor and encoder would be provided to time the cut on both drives to protect the blade assemblies. Optionally, an electronic controlled system is provided for monitoring trim disposal, blade position (in relation to inserter position), blade cycles, jam identification and safety interlock status.

The prior art method and devices made the drop cut slit in a separate operation. Since the sheet is cut apart, pages are loose, so if a tray is mishandled there is a chance of losing or mixing up pages. The present invention resolves this problem by performing the drop cutting process with an in-line nested drop cut assembly that receives the folded document directly from the upstream processing units or friction feeders and delivers the document with the nested drop cut directly to the downstream equipment, such as an inserter. The present invention provides one continuous, secure, in-line machine. The present invention allows cutting the top or bottom panel or page.

Various features of the invention have been particularly shown and described in connection with the illustrated embodiments of the invention, however, it must be understood that these particular embodiments merely illustrate and that the invention is to be given its fullest interpretation within the terms of the appended claims.

I claim:

1. An automated in-line drop cut apparatus for nested drop cutting of a folded document comprising:
a) a pathway for receiving and transporting continuously fed folded documents from an upstream feeder, said pathway for receiving and transporting operable to transport said documents downstream to and from a drop cut unit; and,
b) said drop cut unit including at least one cutter for cutting said folded documents along a document folded edge parallel to the direction of document travel, and said at least one cutter positioned adjacent said pathway for receiving and transporting.

2. The automated in-line drop cut unit apparatus of claim 1, wherein said pathway for receiving and transporting said document from said upstream feeder comprises a raceway insert track having a drive chain including pusher pins operable for engaging and supplying a motive force to said documents.

3. The automated in-line drop cut unit apparatus of claim 1, wherein said at least one cutter for cutting comprises a rotary cutting assembly positioned adjacent to said pathway for receiving and transporting said document, said cutting assembly comprising an anvil blade and a rotary drum having a blade, said anvil blade adapted to support said documents during cutting by said blade, said rotary drum having a rotational axis parallel to the direction of document travel.

4. The automated in-line drop cut unit apparatus of claim 1, wherein said at least one cutter for cutting comprises a first rotary cutting assembly and a second rotary cutting assembly, said first and second rotary cutting assemblies being positioned on opposite sides of said pathway for receiving and transporting, said first and second rotary cutting assemblies each comprising an anvil blade and a rotary drum having a blade, said anvil blade adapted to support said documents during cutting by said blade, said rotary drum having a rotational axis parallel to the direction of document travel, said first and second rotary cutting assemblies being independently operable for selective positioning adjacent said pathway for receiving and transporting.

5. The automated in-line drop cut unit apparatus of claim 1, wherein both said pathway for receiving and transporting and said cutter being operable in coordination with an inserter for sequential operation.

6. The automated in-line drop cut unit apparatus of claim 1, wherein both said pathway for receiving and transporting and said cutter share a common supplier of motive power.

7. The automated in-line drop cut unit apparatus of claim 1, wherein said drop cut unit includes a hold down apparatus operable to limit the upward mobility of said document and secure said document adjacent said cutter for cutting.

8. An automated in-line drop apparatus comprising:
a) a means for receiving and transporting continuously fed folded documents from an upstream feeder, said means for receiving and transporting operable to transport said documents downstream to and from a drop cut unit; and,
b) said drop cut unit including at least one means for cutting said folded document along a document folded edge parallel to the direction of document travel, and said at least one means for cutting positioned adjacent said means for receiving and transporting.

9. A method of producing nested drop cut documents in-line comprising the steps of:
a) receiving a continuous stream of folded forms for drop cutting from an upstream feeder, said folded forms having a drop cut panel, an extended drop cut fold edge, a top side and a bottom side;
b) sequencing said folded forms from said upstream feeder and directing said forms to an in-line drop cut apparatus, said apparatus having a cutting assembly operable to cut said drop cut fold edge along a cut line parallel to the direction of form travel;
c) cutting said drop cut fold edge with said cutting assembly thereby separating a drop cut panel from the folded form; and,
e) directing said folded forms and said drop cut panels together downstream of said in-line drop cut apparatus.

10. The method according to claim 9, wherein said method further comprises receiving said folded forms and said drop cut panels by an inserter downstream of said in-line drop cut apparatus.

11. The method of claim 9, wherein the steps of receiving said folded forms from said upstream feeder and cutting said drop cut fold edge are sequentially linked to said inserter downstream of said in-line drop cut apparatus.

12. The method of claim 9, wherein said cutting step is performed by a cutting assembly having an anvil blade and a rotary drum having a rotational axis parallel to the direction of document travel, said rotary drum including a blade operable to cut a portion of said folded form along a folded edge.
